(19) United States
(12) Patent Application Publication
(10) Pub. No.: US 2015/0118563 A1
(43) Pub. Date: Apr. 30, 2015

(54) LITHIUM-RICH POSITIVE ELECTRODE MATERIAL, LITHIUM BATTERY POSITIVE ELECTRODE, AND LITHIUM BATTERY

(71) Applicant: Huawei Technologies Co., Ltd., Shenzhen (CN)

(72) Inventor: Chaohui Chen, Shenzhen (CN)

(21) Appl. No.: 14/587,603

(22) Filed: Dec. 31, 2014

Related U.S. Application Data
(63) Continuation of application No. PCT/CN2013/073371, filed on Mar. 28, 2013.

(30) Foreign Application Priority Data
Nov. 15, 2012 (CN) 201210458830.X

(51) Int. Cl. H01M 4/36; H01M 4/04; H01M 4/131; H01M 10/052

(52) U.S. Cl. CPC H01M 4/366; H01M 10/052; H01M 4/0402; H01M 4/131; H01M 4/0471; H01M 2220/20; H01M 2220/30
USPC 429/221; 429/231.1; 429/224; 429/223; 429/231.2; 429/231.3; 252/521.2; 252/519.15

(57) ABSTRACT

The present invention discloses a lithium-rich positive electrode material, a lithium battery positive electrode, and a lithium battery. The lithium-rich positive electrode material has a coating structure, where a general structural formula of a core of the coating structure is as follows: z[xLi₂MO₃·(1−x)LiMeO₂]·(1−z)Li_{1+d}My_{2-d}O, where in the formula, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co; and a coating layer of the coating structure is a compound whose general formula is MₘM_{z}, where in the formula, Mₘ is at least one of Zn, Ti, Zr, and Al, and M_{z} is O or F. The lithium battery positive electrode and the lithium battery both include the lithium-rich positive electrode material.

### CROSS-REFERENCE TO RELATED APPLICATIONS

This application is a continuation of International Application No. PCT/CN2013/073371, filed on Mar. 28, 2013, which claims priority to Chinese Patent Application No. 201210458830.X, filed on Nov. 15, 2012, both of which are hereby incorporated by reference in their entireties.

### TECHNICAL FIELD

The present invention relates to the field of battery technologies, and in particular, to a lithium-rich positive electrode material, a lithium battery positive electrode, and a lithium battery.

### BACKGROUND

In many energy storage technologies, lithium-ion batteries are considered as next-generation high-efficiency portable chemical electric power sources because the lithium-ion batteries have the advantages of high energy density, a long cycle life, light weight, non-pollution, and the like. Currently, the lithium-ion batteries are widely used in digital cameras, smart phones, notebook computers, and other fields. With further enhancement of the energy density of the lithium-ion batteries, the lithium-ion batteries will be gradually applied in electric vehicles (electric bicycles, electric cars, and hybrid electric cars), power grids, and other massive energy storage fields.

Currently, with an increasingly growing demand of mobile electronic devices on high-capacity and long-service-life batteries, people have higher requirements on performance of lithium-ion batteries. The low capacity of the lithium-ion batteries has become a bottleneck limiting the development of the battery industry. The development of positive electrode materials has become a key factor limiting further enhancement of energy density of the lithium-ion batteries. Currently, common positive electrode materials are lithium cobalt oxide (LCO), lithium manganese oxide (LMO), lithium iron phosphate (LFP), nickel cobalt manganese (NCM) oxide, and the like, but specific capacities of these positive electrode materials are mostly lower than 160 mAh/g.

To further improve the specific capacities of the positive electrode materials, a lithium-rich manganese-based solid solution (xLi₂MnO₃·(1−x)LiMO₂, with a layered-layered structure, where M is one or more of Ni, Co, Mn, Ti, and Zr) is put forward in recent years. Because the lithium-rich manganese-based solid solution has a high discharge capacity (the discharge capacity is greater than 250 mAh/g, and a charge voltage is greater than 4.6 V) and costs are very low, the lithium-rich manganese-based solid solution becomes a development direction of next-generation positive electrode materials. However, the Layered-Layered lithium-rich solid solution also has a serious defect: in processes of charge and discharge (>4.5 V), sensitization reactions occur on a surface. Specific reactions are as follows:

LiMO₂→Li₁₋ₓMO_{2-δ}+x Li⁺+δ/2 O₂+xe (1)

Li₂MnO₃→MnO₂+2 Li⁺+½ O₂+2 e (2)

The foregoing reactions that occur on the surface of the Layered-Layered lithium-rich solid solution material have the following adverse impact on the electrochemical performance of the material:

(1) O₂ is generated, and consequently, Li₂O is formed; in a charge process, it is difficult to reduce Li₂O to Li, which results in very low initial charge and discharge efficiency (approximately 70%).

(2) Cycle performance of the material is also restricted as the structure changes.

(3) The surface is destroyed, which also produces adverse impact on rate performance of the material.

In addition, when electric potential of a positive electrode is higher than 4.5 V, manganese in the Layered-Layered lithium-rich solid solution material may be precipitated in a cycle process, which results in quick attenuation of the capacity of the material.

To sum up, the existing lithium-rich solid solution with the Layered-layered structure has a theoretically high specific capacity; however, the instability of the material in a high-voltage condition causes quick attenuation of the capacity.

Considering the defects of the lithium-rich solid solution with the Layered-layered structure, researchers modify the material, so as to remedy the defects of the material. Specific measures are as follows:

1. A lithium-rich solid solution with a Layered-rocksalt structure:

Argonne National Laboratory synthesized a new structure, namely, Layered-rocksalt: xLi₂MnO₃·(1−x)MO, where 0≦x≦1, and used the new structure in a positive electrode material of a lithium-ion battery. The lithium-rich solid solution with the new structure shows good initial charge and discharge performance and good cycle performance.

However, the lithium-rich solid solution with the Layered-rocksalt structure also has a disadvantage: when the lithium-rich solid solution material with the Layered-rocksalt structure is used in a lithium-ion battery, content of Li is reduced (compared with a conventional Layered-Layered solid solution xLi₂MnO₃·(1−x)LiMO₂,where 0≦x≦1), which reduces a discharge capacity of the material.

2. A lithium-rich solid solution with a Layered-Spinel structure:

A. Manthiram and others synthesized a new lithium-rich solid solution Layered-Spinel structure:

xLi [Li_{0.2}Mn_{0.6}Ni_{0.17}Co_{0.03}]O₂·(1−x ) Li[Mn_{1.5}Ni_{0.452}Co_{0.075}]O₄, where and used the new structure in a positive electrode material of a lithium-ion battery. With the stability of the Spinel structure, the positive electrode material shows good initial charge and discharge efficiency and good cycle performance.

However, the lithium-rich solid solution with the Layered-Spinel structure also has a disadvantage: the stability of the material with the Spinel structure is better than that of the Layered structure, but a discharge capacity of the material with the Spinel structure is lower; therefore, performance of a positive electrode material with the Layered-Spinel structure is lower than that of a positive electrode material with the Layered-Layered structure.

It can be learned from the foregoing descriptions that all of the existing lithium-rich solid solution materials have disadvantages such as poor stability, low discharge capacity, poor cycle performance in a high-voltage condition, and are difficult to commercialize.

### SUMMARY

An objective of the embodiments of the present invention is to overcome the foregoing disadvantages in the prior art, and provide a lithium-rich positive electrode material with a stable structure, a high discharge capacity, and good cycle performance.

Another objective of the embodiments of the present invention is to provide a lithium battery positive electrode including the lithium-rich positive electrode material.

Still another objective of the embodiments of the present invention is to provide a lithium battery including the lithium battery positive electrode.

In order to achieve the foregoing objectives of the invention, technical solutions of the present invention are as follows:

A lithium-rich positive electrode material, which has a coating structure,

where a general structural formula of a core of the coating structure is as follows:

z[xLi₂MO₃·(1−x)LiMeO₂]·(1−z)Li_{1+d}My_{2-d}O, where in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co; and

a coating layer of the coating structure is a compound whose general formula is MₘM_{z}, where in the formula, Mₘ is at least one of Zn, Ti, Zr, and Al, and M_{z} is O or F.

Preferably, a ratio of a radius of the core to a thickness of the coating layer is (25 to 100):1.

Preferably, Li_{1+d}My_{2-d}O in the general structural formula of the core has a spinel structure.

Preferably, xLi₂MO₃·(1−x)LiMeO₂ in the general structural formula of the core has a layered structure.

Preferably, a particle size of the lithium-rich positive electrode material is 5 μm to 10 μm.

A method for preparing the foregoing lithium-rich positive electrode material, including the following steps:

obtaining a precursor of the lithium-rich positive electrode material whose general structural formula is z[xLi₂MO₃·(1−x)LiMeO₂]·(1−z)Li_{1+d}My_{2-d}O, where in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co; and

dispersing the precursor of the lithium-rich positive electrode material in a solution including an Mₘ salt, then adding an oxyhydroxide solution and stirring at 50 to 120° C. so that a reaction occurs, and then performing solid-liquid separation, washing, and drying, to obtain a first dried mixture, where Mₘ is at least one of Zn, Ti, Zr, and Al; or

dispersing the precursor of the lithium-rich positive electrode material in a solution including an Mₘ salt and a fluoride, and then stirring at 50 to 120° C. until the solution is dried, to obtain a second dried mixture, where Mₘ is at least one of Zn, Ti, Zr, and Al; and

calcining the first dried mixture or the second dried mixture at 250 to 550° C. for 0.5 to 12 hours to obtain the lithium-rich positive electrode material.

Preferably, the Mₘ salt is at least one of a nitrate, a sulphate, an acetate, and a chloride.

Preferably, the oxyhydroxide is at least one of NH₄OH, NaOH, and LiOH.

Preferably, in the step of preparing the first dried mixture and/or the second dried mixture, the precursor of the lithium-rich positive electrode material is dispersed in a mixed solution formed by the solution including the Mₘ salt, and a molar ratio of the precursor of the lithium-rich positive electrode material to the Mₘ salt is (25 to 100):1.

Preferably, in the step of preparing the first dried mixture, after the oxyhydroxide solution is added, pH of the solution including the Mₘ salt is adjusted to 9 to 12.

Specifically, in the step of preparing the first dried mixture, the Mₘ salt is a nitrate of Mₘ, and the oxyhydroxide is NH₄OH.

Preferably, in the step of preparing the second dried mixture, pH of the solution including the Mₘ salt and the fluoride is 5 to 9.

Specifically, in the step of preparing the second dried mixture, the Mₘ salt is a nitrate of Mₘ, and the fluoride is NH₄F.

Preferably, a method for obtaining the precursor of the lithium-rich positive electrode material is:

weighing a soluble M salt, a soluble Me salt, a soluble My salt and a lithium compound according to molar stoichiometric ratios of corresponding elements in the general structural formula z[xLi₂MO₃·(1−x)LiMeO₂]·(1−z)Li_{1+d}My_{2-d}O;

dissolving the M salt, the Me salt, and the My salt to prepare a mixed solution;

adding the mixed solution dropwise to the oxyhydroxide solution and stirring so that a reaction occurs, and successively performing solid-liquid separation, washing, and drying on a generated deposit to obtain a dried deposit; and

mixing the deposit with the lithium compound and performing sintering treatment, so as to obtain the precursor of the lithium-rich positive electrode material whose general structural formula is z[xLi₂MO₃·(1−x)LiMeO₂]·(1−z)Li_{1+d}My_{2-d}O.

Further preferably, the M salt is at least one of an acetate, a nitrate, a sulphate, and a chloride of M.

Further preferably, the Me salt is at least one of an acetate, a nitrate, a sulphate, and a chloride of Me.

Further preferably, the My salt is at least one of an acetate, a nitrate, a sulphate, and a chloride of My.

Further preferably, the lithium compound is at least one of lithium hydroxide and a lithium salt.

Further preferably, a temperature of the sintering treatment is 500 to 1000° C., and a sintering time is 4 to 12 h.

And, a lithium battery positive electrode, including a current collector and a positive electrode material combined on the current collector, where the positive electrode material is the foregoing lithium-rich positive electrode material.

And, a lithium battery, where the lithium battery includes the foregoing lithium battery positive electrode.

### BENEFICIAL EFFECT

In the foregoing embodiments, the lithium-rich positive electrode material has a coating structure, and a coating layer in the coating structure can effectively restrain a lithium-rich phase material and a spinel phase in a core from contacting an electrolyte, which reduces a sensitization reaction on a surface of the lithium-rich positive electrode material and effectively reduces impact of hydrofluoric (HF) acid on the lithium-rich phase material and the spinel phase, thereby suppressing precipitation of Me in the lithium-rich phase material, decelerating the decrease of a voltage platform in a cycle process, and improving cycle performance of the material. In addition, electrical conductivity of the coating layer of the lithium-rich positive electrode material is better than electrical conductivity of the core, which effectively improves rate performance of the lithium-rich positive electrode material. Secondly, the coating structure is used, so that the structure of the lithium-rich positive electrode material is stable and a stable electric connection is kept between the coating layer and the core, thereby making electron conduction stable and improving electrochemical performance of the lithium-rich positive electrode material.

In the foregoing embodiments, in the method for preparing a lithium-rich positive electrode material, technologies of the processes are mature, conditions are easy to control, and the production efficiency is high, thereby reducing production costs.

In the foregoing embodiments, the lithium battery positive electrode includes the lithium-rich positive electrode material and the lithium-rich positive electrode material has the excellent performance described above; therefore, during working, the lithium battery positive electrode has a high capacity, stable performance, and a long cycle life.

In the foregoing embodiments, because the lithium battery includes the lithium battery positive electrode, the lithium battery has an excellent cycle life and rate performance, thereby effectively solving the problem of the decrease of the voltage platform. Because the lithium battery has the excellent performance, the application scope of the lithium battery is expanded.

### BRIEF DESCRIPTION OF THE DRAWINGS

The present invention is further described in the following with reference to the accompanying drawings and embodiments. In the accompanying drawings:

FIG. 1 is a schematic structural diagram of a lithium-rich positive electrode material according to an embodiment of the present invention;

FIG. 2 is a flowchart of a method for preparing a lithium-rich positive electrode material according to an embodiment of the present invention;

FIG. 3 is a flowchart of another method for preparing a lithium-rich positive electrode material according to an embodiment of the present invention;

FIG. 4 is a flowchart of a method for preparing a lithium battery positive electrode according to an embodiment of the present invention; and

FIG. 5 is a flowchart of a method for preparing a lithium battery according to an embodiment of the present invention.

### DETAILED DESCRIPTION

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

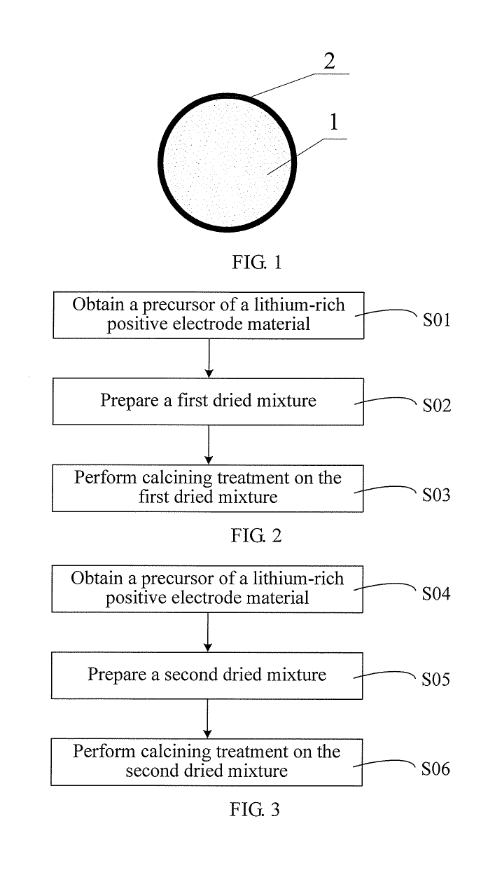

An embodiment of the present invention provides a lithium-rich positive electrode material with a stable structure, a high discharge capacity, and good cycle performance. The lithium-rich positive electrode material has a coating structure, and includes a core 1 and a coating layer 2. FIG. 1 shows a microstructure of the lithium-rich positive electrode material. A general structural formula of the core 1 is as follows:

z[xLi₂MO₃·(1−x)LiMeO₂]·(1−z)Li_{1+d}My_{2-d}O, where in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co. xLi₂MO₃·(1−x)LiMeO₂ in the general structural formula of the core 1 has a layered structure, and Li_{3-2y}M′_{2y}PO₄ is distributed, with a spinel structure, in lattices of xLi₂MO₃·(1−x)LiMeO₂. The coating layer 2 is a compound whose general formula is MₘM_{z}, where in the formula, Mₘ is at least one of Zn, Ti, Zr, and Al, and M_{z} is O or F.

Further, by means of research, an inventor finds that, by properly adjusting a ratio of a radius of the core 1 to a thickness of the coating layer 2 of the lithium-rich positive electrode material in this embodiment, a lithium-rich phase material and a spinel phase in the core 1 can be better restrained from contacting an electrolyte, and a sensitization reaction on a surface of the lithium-rich positive electrode material is reduced, which effectively reduces impact of HF on the lithium-rich phase material and the spinel phase, thereby suppressing precipitation of Me in the lithium-rich phase material, decelerating the decrease of a voltage platform in a cycle process, and improving cycle performance of the material. Therefore, in an exemplary embodiment, the ratio of the radius of the core 1 to the thickness of the coating layer 2 of the lithium-rich positive electrode material is (25 to 100):1.

By means of research, the inventor further finds that a discharge capacity, rate performance, initial charge and discharge efficiency, and cycle life of the lithium-rich positive electrode material can be effectively improved by controlling a particle size of the lithium-rich positive electrode material in the foregoing embodiment. Therefore, in an exemplary embodiment, the particle size of the lithium-rich positive electrode material is 5 μm to 10 μm.

It can be learned from the foregoing descriptions that, in the foregoing embodiment, a coating layer 2 in a coating structure of a lithium-rich positive electrode material can effectively restrain a lithium-rich phase material and a spinel phase from contacting an electrolyte in a core 1, which reduces a sensitization reaction on a surface of the lithium-rich positive electrode material and effectively reduces impact of HF on the lithium-rich phase material and the spinel phase, thereby suppressing precipitation of Me in the lithium-rich phase material, decelerating the decrease of a voltage platform in a cycle process, and improving cycle performance of the material. Electrical conductivity of the coating layer 2 of the lithium-rich positive electrode material is better than electrical conductivity of the core 1, which effectively improves rate performance of the lithium-rich positive electrode material. Secondly, the coating structure is used, so that the structure of the lithium-rich positive electrode material is stable and a stable electric connection is kept between the coating layer 2 and the core 1, thereby making electron conduction stable and improving electrochemical performance of the lithium-rich positive electrode material. In addition, by adjusting a content relationship between the core 1 and the coating layer 2, the lithium-rich phase material and the spinel phase in the core of the lithium-rich positive electrode material can be further effectively restrained from contacting the electrolyte, and the sensitization reaction on the surface of the lithium-rich positive electrode material is reduced. By adjusting types and content of elements in the core 1, the initial charge and discharge efficiency and the cycle life of the lithium-rich positive electrode material can be further improved.

Correspondingly, an embodiment of the present invention further provides a method for preparing the foregoing lithium-rich positive electrode material. For a technological process of the method for preparing the lithium-rich positive electrode material, refer to FIG. 2. The method specifically includes the following steps:

Step S01: Obtain a precursor of the lithium-rich positive electrode material:

obtain the precursor of the lithium-rich positive electrode material whose general structural formula is z[xLi₂MO₃·(1−x)LiMeO₂]·(1−z)Li_{1+d}My_{2-d}O, where in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co.

Step S02: Prepare a first dried mixture:

disperse the precursor, which is prepared in step S01, of the lithium-rich positive electrode material in a solution including an Mₘ salt, then add an oxyhydroxide solution and stir at 50 to 120° C. so that a reaction occurs, and then perform solid-liquid separation, washing, and drying, to obtain the first dried mixture, where Mₘ is at least one of Zn, Ti, Zr, and Al.

Step S03: Perform calcining treatment on the first dried mixture:

calcine the first dried mixture, which is prepared in step S02, at 250 to 550° C. for 0.5 to 12 hours, to obtain the lithium-rich positive electrode material.

Specifically, the precursor, in step S01, of the lithium-rich positive electrode material whose general structural formula is z[xLi₂MO₃·(1−x)LiMeO₂]·(1−z)Li_{1+d}My_{2-d}O may be purchased on the market. The precursor can also be obtained according to the following preparation method. The preparation method of the precursor includes the following steps:

Step S011: Weigh a soluble M salt, a soluble Me salt, a soluble My salt, and a lithium compound according to molar stoichiometric ratios of corresponding elements in the general structural formula z[xLi₂MO₃·(1−x)LiMeO₂]·(1−z)Li_{1+d}My_{2-d}O.

Step S012: Dissolve the M salt, the Me salt, and the My salt in step S011 to prepare a mixed solution.

Step S013: Add the mixed solution prepared in step S012 dropwise to the oxyhydroxide solution and stir so that a reaction occurs, and successively perform solid-liquid separation, washing, and drying on a generated deposit to obtain a dried deposit.

Step S014: Mix the deposit prepared in step S013 with the lithium compound and perform sintering treatment, so as to obtain the precursor of the lithium-rich positive electrode material whose general structural formula is z[xLi₂MO₃·(1−x)LiMeO₂]·(1−z)Li_{1+d}My_{2-d}O.

In step S011, the M salt is preferably selected from at least one of an acetate, a nitrate, a sulphate, and a chloride of M; the Me salt is preferably selected from at least one of an acetate, a nitrate, a sulphate, and a chloride of Me; the My salt is preferably selected from at least one of an acetate, a nitrate, a sulphate, and a chloride of My; and the lithium compound is preferably selected from at least one of lithium hydroxide and a lithium salt, where the lithium salt may be a common lithium salt in the field. As an exemplary embodiment, a molar ratio of the M salt, the Me salt, and the My salt is 1:(0.1 to 0.4):(0.01 to 0.1). To ensure content of the lithium element in the precursor of the lithium-rich positive electrode material, for the final amount of the lithium compound, additional 3% to 8% (a mass ratio) is weighed based on the amount that is weighed according to the general structural formula.

In step S012, a solvent used for dissolving the M salt, the Me salt, and the My salt is preferably water, and is more preferably distilled water. Certainly, another solvent that is commonly known in the field and can dissolve the M salt, the Me salt, and the My salt may also be selected as the solvent. In the prepared mixed solution, a concentration of the M salt, the Me salt or the My salt is preferably 0.1 mol/L to 10 mol/L. Certainly, in this embodiment, the concentration of the mixed solution is not specifically limited.

In step S013, after the mixed solution is slowly added to the oxyhydroxide solution dropwise, the M, Me, and My ions are combined with OH⁻ to generate a deposit. The amount of the oxyhydroxide should be sufficient, to make sure that the M, Me, and My ions are completely deposited. The oxyhydroxide may be a common soluble oxyhydroxide in the field, and preferably, is potassium hydroxide, and a concentration of an oxyhydroxide solution is 1 to 4 mol/L.

Common methods in the field may be used for the solid-liquid separation and washing in step S013, and in this embodiment of the present invention, there is no special restrictions and requirements on the methods. The drying is preferably baking the washed deposit at 100° C. for 8 to 24 hours, so as to remove a reaction solvent and a washing solution.

In step S014, before the deposit is mixed with the lithium compound, the deposit is preferably pulverized; then the pulverized deposit is evenly mixed with the lithium compound, and the mixture is pressed into small balls by using a common method in the field; then, sintering treatment is performed on the small balls. A temperature of the sintering treatment is preferably 500 to 1000° C., and a sintering time is preferably 4 to 12 h.

Specifically, in step S02, after the oxyhydroxide is added, the OH⁻ is combined with Mₘ ions to generate a deposit; and by means of adsorption of an electric charge, the deposit is adsorbed on surfaces of particles of the precursor of the lithium-rich positive electrode material. The Mₘ salt is preferably selected from at least one of a nitrate, a sulphate, an acetate, and a chloride of Mₘ. The oxyhydroxide is preferably selected from at least one of NH₄OH, NaOH, and LiOH. To deposit the Mₘ ions to a greatest extent, in an exemplary embodiment, the Mₘ salt is Mₘ (NO₃), the oxyhydroxide is NH₄OH, and by controlling the amount of added NH₄OH, pH of a reaction system including the Mₘ salt solution is adjusted to 9.0 to 12.0.

In step S02, preferably, a manner of dispersing the precursor of the lithium-rich positive electrode material in the solution in which the Mₘ salt is dissolved is pulverizing the precursor of the lithium-rich positive electrode material first, and then dispersing the pulverized precursor in the solution in an ultrasonic dispersion manner. Certainly, another manner commonly known in the field may also be used for dispersion. Regardless of which manner is used for dispersion, the precursor of the lithium-rich positive electrode material should be evenly dispersed in the solution in which the Mₘ salt is dissolved. Water may be selected as a solvent used for dissolving the Mₘ salt, and certainly, another solvent that is common in the field and can dissolve the Mₘ salt may also be selected. In the mixed solution in which the precursor of the lithium-rich positive electrode material is dispersed, the molar ratio of the precursor of the lithium-rich positive electrode material to the Mₘ salt is preferably (25 to 100):1. By using the preferable amount proportion, content of both the coating layer and the core of the lithium-rich positive electrode material can be effectively controlled, thereby achieving excellent performance of the lithium-rich positive electrode material.

Common methods in the field may be used for the solid-liquid separation and washing in step S02, and in this embodiment of the present invention, there is no special restrictions and requirements on the methods. The drying is preferably baking the washed deposit at 100° C. for 8 to 24 hours, so as to remove a reaction solvent and a washing solution.

In step S03, in the calcining condition, the deposit adsorbed on the surface of the precursor of the lithium-rich positive electrode material is melted and decomposed to generate an MₘO coating layer, thereby forming the lithium-rich positive electrode material with a structure shown in FIG. 1.

Correspondingly, an embodiment of the present invention further provides another method for preparing the foregoing lithium-rich positive electrode material. For a technological process of the method for preparing the lithium-rich positive electrode material, refer to FIG. 3. The method specifically includes the following steps:

Step S04: Obtain a precursor of the lithium-rich positive electrode material: the same as step S01 of the foregoing first method for preparing the lithium-rich positive electrode material.

Step S05: Prepare a second dried mixture:

disperse the precursor, which is prepared in step S04, of the lithium-rich positive electrode material in a solution including an Mₘ salt and a fluoride, and then stir at 50 to 120° C. until the solution is dried, to obtain the second dried mixture, where Mₘ is at least one of Zn, Ti, Zr, and Al.

Step S06: Perform calcining treatment on the second dried mixture:

calcine the second dried mixture, which is prepared in step S05, at 250 to 550° C. for 1 to 12 hours, to obtain the lithium-rich positive electrode material.

Specifically, the precursor, in step S04, of the lithium-rich positive electrode material whose general structural formula is z[xLi₂MO₃·(1−x)LiMeO₂]·(1−z)Li_{1+d}My_{2-d}O may be purchased on the market. For a preferable method for obtaining the precursor, refer to the foregoing steps S011 to S014, and details are not described herein again.

In step S05, the Mₘ salt is preferably selected from at least one of a nitrate, a sulphate, an acetate, and a chloride of Mₘ. The fluoride is preferably NH₄F. To deposit the Mₘ ions to a greatest extent, in an exemplary embodiment, the Mₘ salt is Mₘ(NO₃), the fluoride is NH₄F, and by controlling the amount of added NH₄F, pH of a reaction system including the Mₘ salt solution is adjusted to 5.0 to 9.0.

In step S05, preferably, a manner of dispersing the precursor of the lithium-rich positive electrode material in the solution including the Mₘ salt and the fluoride is pulverizing the precursor of the lithium-rich positive electrode material first, and then dispersing the pulverized precursor in the solution in an ultrasonic dispersion manner. Certainly, another manner commonly known in the field may also be used for dispersion. Regardless of which manner is used for dispersion, the precursor of the lithium-rich positive electrode material should be evenly dispersed in the solution in which the Mₘ salt is dissolved. In the mixed solution in which the precursor of the lithium-rich positive electrode material is dispersed, the molar ratio of the precursor of the lithium-rich positive electrode material to the Mₘ salt is preferably (25 to 100):1. By using the preferable amount proportion, content of both the coating layer and the core of the lithium-rich positive electrode material can be effectively controlled, thereby achieving excellent performance of the lithium-rich positive electrode material.

In step S06, in the calcining condition, molecules of the Mₘ salt and the fluoride are rearranged and an MₘF coating layer is generated, thereby forming the lithium-rich positive electrode material with a structure shown in FIG. 1.

As described in the foregoing, in the method for preparing a lithium-rich positive electrode material, the processes are simple, technologies of the processes are mature, conditions are easy to control, and the production efficiency is high, thereby reducing production costs.

The present invention further provides a lithium battery positive electrode, which includes a current collector and a positive electrode material combined on the current collector, where the positive electrode material is the foregoing lithium-rich positive electrode material. To simplify the description, details are not described herein again. A common current collector in the field, for example, a copper foil, may be selected as the current collector. In this manner, the lithium battery positive electrode includes the foregoing lithium-rich positive electrode material, and the lithium-rich positive electrode material has the excellent performance; therefore, during working, the lithium battery positive electrode has stable performance, a high capacity, and a long cycle life.

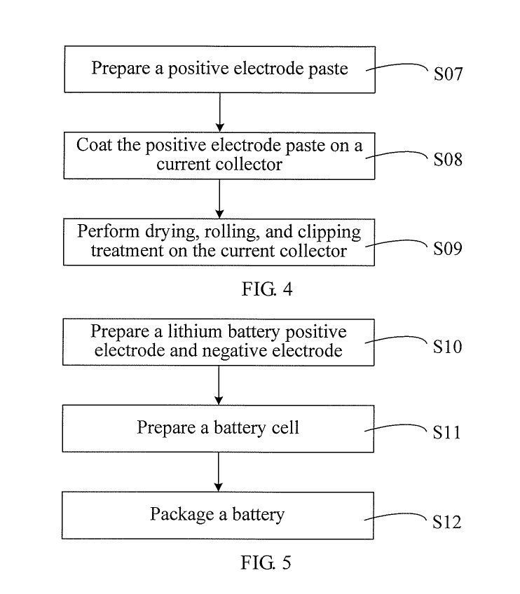

Correspondingly, an embodiment of the present invention further provides a method for preparing the foregoing lithium battery positive electrode. For a technological process of the method for preparing the lithium battery positive electrode, refer to FIG. 4. The method includes the following steps:

Step S07: Prepare a positive electrode paste: mix the foregoing lithium-rich positive electrode material with an electrode conductive agent, an adhesive, and a solvent to prepare the positive electrode paste.

Step S08: Coat the positive electrode paste prepared in step S07 on a current collector.

Step S09: Perform drying, rolling, and clipping treatment on the current collector: dry, roll, and clip the current collector that is processed in step S08 and coated with the positive electrode paste, to obtain a lithium battery positive electrode.

Specifically, a weight ratio of the lithium-rich positive electrode material, the electrode conductive agent, the adhesive, and the solvent in step S07 is preferably (8 to 9.5):(0.2 to 1.5):(0.3 to 1):100, and is more preferably 8:1:1:100. The electrode conductive agent is graphite, the adhesive is carboxymethyl cellulose (CMC), and the solvent is preferably water. Certainly, other common substances in the field may also be selected as the electrode conductive agent, the adhesive, and the solvent.

Common methods in the field may be used as a manner of coating the positive electrode paste in step S08 and a manner of drying, rolling, and clipping the current collector in step S09.

In the method for preparing a lithium battery positive electrode, it is only required to coat a positive electrode paste including the foregoing lithium-rich positive electrode material on a current collector, and then dry, roll, and clip the current collector; the method is simple, conditions are easy to control, and the qualified rate and the production efficiency are high.

An embodiment of the present invention further provides a lithium battery, where the lithium battery includes the foregoing lithium battery positive electrode.

As an exemplary embodiment, the lithium battery is a chemical lithium battery, such as a lithium-ion battery or a lithium polymer battery, having an electrochemical reaction.

In this manner, the lithium battery includes the foregoing lithium battery positive electrode, and therefore, during a charge and discharge cycle process, the lithium battery has stable electrochemical performance, a high capacity, and a long life.

Correspondingly, an embodiment of the present invention further provides a method for preparing the lithium battery. For a technological process of the method for preparing the lithium battery, refer to FIG. 3. The method includes the following steps:

Step S10: Prepare a positive electrode and a negative electrode of the lithium battery, where the lithium battery positive electrode is prepared by using the foregoing method for preparing a lithium battery positive electrode.

Step S11: Prepare a battery cell: successively laminate, according to a lamination manner of lithium battery positive electrode/separator/lithium battery negative electrode, the positive electrode and the negative electrode of the battery that are prepared in step S10, and then wind the stacked battery positive electrode and negative electrode to obtain a battery cell.

Step S12: Package a battery: place the cell into a battery housing, then fill the battery housing with an electrolyte, and seal the battery housing, to obtain a lithium battery.

Specifically, the preparation of the positive electrode in step S10, the preparation of the battery cell in step S11, and the packaging of the battery in step S12 may all be performed according to common methods in the field. The battery cell in step S11 may be square or in another shape required by a different lithium battery. In this manner, technologies of processes of the method for preparing a lithium battery are mature, conditions are easy to control, and the qualified rate is high.

This embodiment of the present invention further provides an application scope of the foregoing lithium battery. The application scope includes mobile terminal products, electric cars, power grids, communications devices, electric power tools, and the like. For example, when the lithium battery is a lithium-ion battery, the lithium-ion battery is applied in a communications device. Specifically, the communications device includes a working module and a power supply module. The power supply module supplies electric power to the working module, and includes the foregoing lithium-ion battery, where the number of the lithium-ion batteries may be one or more than two. When the power supply module includes more than two lithium-ion batteries, the lithium-ion batteries may be connected in parallel, or connected in series, or connected in parallel-series according to the requirement of the electric power required by the working module. The working module operates by using the electric power supplied by the power supply module. In this manner, because the lithium battery has excellent energy density, discharge capacity, cycle life, and rate performance, the application scope of the lithium-ion battery is effectively expanded. When the lithium-ion battery is applied in a mobile terminal product, an electric car, a power grid, a communications device, and an electric power tool, the lithium-ion battery can effectively provide stable and constant electric power for a working module in the mobile terminal product, the electric car, the power grid, the communications device, and the electric power tool, thereby reducing a replacement frequency of an electrochemical power source and making it more simple and convenient for a user to use the mobile terminal product, the electric car, the power grid, the communications device, and the electric power tool.

Aspects such as the foregoing lithium-rich positive electrode material and the preparation method thereof, the lithium battery positive electrode and the preparation method thereof, and the lithium battery and the preparation method thereof are described in the following by using examples and multiple embodiments.

### Embodiment 1

A lithium-rich positive electrode material, which has a coating structure, where a general structural formula of a core of the coating structure is 0.85[0.9 Li₂MnO₃·0.1 LiMn_{0.5}Ni_{1.5}O₂]·0.15 LiMn₂O₄, and a coating layer is a compound whose general formula is ZnO. A method for preparing the lithium-rich positive electrode material is as follows:

Step S11: Prepare a precursor of the lithium-rich positive electrode material whose general structural formula is 0.85[0.9 Li₂MnO₃·0.1 LiMn_{0.5}Ni_{1.5}O₂]·0.15 LiMn₂O₄.

S011: Dissolve manganese acetate and nickel acetate (2 mol/L) with a molar ratio of 1:0.035 in 50 ml of water, so as to obtain a mixed solution.

Step S012: Slowly add the mixed solution in step S011 dropwise to a potassium hydroxide solution whose concentration is 2 mol/L, stir so that a reaction lasts 1 hour, and successively filter a generated deposit, wash the deposit by using distilled water, and dry the deposit at 100° C. for 12 hours, so as to obtain a dried deposit.

S013: Mix the deposit in step S012 with lithium hydroxide, where a molar ratio is 1:1.05, and after pulverization, perform sintering treatment at 800° C. for 6 hours, so as to obtain a lithium-rich positive electrode material whose general structural formula is 0.85[0.9 Li₂MnO₃·0.1 LiMn_{0.5}Ni_{1.5}O₂]·0.15 LiMn₂O₄.

Step S12: Perform a coating process of the precursor of the lithium-rich positive electrode material:

after the precursor, in step S11, of the lithium-rich positive electrode material is ground, disperse, in an ultrasonic manner, the precursor in a solution in which zinc acetate is dissolved, stir for 2 hours, then add an ammonium hydroxide solution and adjust pH to 11.5, stir at 70° C. so that a reaction lasts 2 hours, and then successively perform filtering, washing by using distilled water, and drying at 100° C. for 12 hours, so as to obtain a dried product.

Step S13: Calcine the dried product:

pulverize the dried product in step S12, press it into small balls, then place the small balls into a muffle furnace, calcine the small balls at 400° C. for 1 hour, and cool the product, so as to obtain the lithium-rich positive electrode material that is coated with ZnO, has a general structural formula of 0.85[0.9 Li₂MnO₃·0.1 LiMn_{0.5}Ni_{1.5}O₂]·0.15 LiMn₂O₄, and has a coating structure

### Embodiment 2

A lithium-rich positive electrode material, which has a coating structure, where a general structural formula of a core of the coating structure is 0.85[0.8 Li₂MnO₃·0.2 LiCoO ₂]·0.15 LiMn_{1.5}Ni_{0.425}Co_{0.075}O₄, and a coating layer is a compound whose general formula is AlF₃. A method for preparing the lithium-rich positive electrode material is as follows:

Step S21: Prepare a precursor of the lithium-rich positive electrode material whose general structural formula is 0.85[0.8 Li₂MnO₃·0.2 LiCoO₂]·0.15 LiMn_{1.5}Ni_{0.425}Co_{0.075}O₄.

S021: Dissolve manganese acetate, nickel acetate, and cobalt acetate (2 mol/L) with a molar ratio of 1:0.285:0.806 in 50 ml of water, so as to obtain a mixed solution.

S022: Slowly add the mixed solution in step S011 dropwise to a potassium hydroxide solution whose concentration is 2 mol/L, stir so that a reaction lasts 1 hour, and successively filter a generated deposit, wash the deposit by using distilled water, and dry the deposit at 100° C. for 12 hours, so as to obtain a dried deposit.

S023: Mix the deposit in step S012 with lithium hydroxide, where a molar ratio is 1:1.05, and after pulverization, perform sintering treatment at 800° C. for 6 hours, so as to obtain the lithium-rich positive electrode material whose general structural formula is 0.85[0.8 Li₂MnO₃·0.2 LiCoO₂]·0.15 LiMn_{1.5}Ni_{0.425}Co_{0.075}O₄.

Step S22: Perform a coating process of the precursor of the lithium-rich positive electrode material:

after the precursor, in step S11, of the lithium-rich positive electrode material is ground, disperse, in an ultrasonic manner, the precursor in a solution in which aluminum nitrate is dissolved, stir for 2 hours, then add an ammonium fluoride solution, adjust pH to 7, stir at 80° C. so that a reaction lasts 5 hours, and then successively perform filtering, washing by using distilled water, and drying at 100° C. for 12 hours, so as to obtain a dried product.

Step S23: Calcine the dried product:

pulverize the dried product in step S22, press it into small balls, then place the small balls into a muffle furnace, calcine the small balls at 400° C. for 5 hours, and cool the product, so as to obtain the lithium-rich positive electrode material that is coated with AlF₃, has a general structural formula of 0.85[0.8 Li₂MnO₃·0.2 LiCoO₂]·0.15 LiMn_{1.5}Ni_{0.425}Co_{0.075}O₄, and has a coating structure.

### Comparison Example 1

A lithium-rich positive electrode material whose structural formula is 0.85[0.9 Li₂MnO₃·0.1 LiMn_{0.5}Ni_{1.5}O₂]·0.15 LiMn₂O₄.

### Comparison Example 2

A lithium-rich positive electrode material whose structural formula is 0.85[0.8 Li₂MnO₃·0.2 LiCoO₂]·0.15 LiMn_{1.5}Ni_{0.425}Co_{0.075}O₄.

A lithium-ion battery including a lithium-rich positive electrode material and a preparation method thereof:

Preparation of a lithium battery positive electrode: a positive electrode material, an electrode conductive agent, which is graphite, an adhesive, which is CMC, and a solvent, which is water, are mixed according to a proportion, that is, a weight ratio of 8:1:1:100, and are stirred in a high-speed vacuum mixer for 4 to 8 hours, so as to form an even positive electrode paste; the positive electrode paste is evenly coated on a copper foil, and the copper foil is dried in vacuum at 120° C. for 24 hours, and is rolled and clipped to obtain a positive electrode plate with a diameter of 15 mm.

Preparation of a lithium battery negative electrode: a metallic lithium plate with a diameter of 15 mm and a thickness of 0.3 mm.

The positive electrode plate, the negative electrode plate, and a Celgard2400 polypropylene porous membrane are successively laminated according to a lamination sequence of positive electrode plate/separator/negative electrode plate, and are wound to form a square battery electrode core; a battery housing is filled with an electrolyte and sealed, so as to obtain a button lithium-ion battery. The electrolyte is a mixed solution of 1 mol/L of lithium hexafluorophosphate (LiPF₆)+ethylene carbonate/dimethyl carbonate (a volume ratio of EC/DMC is 1:1).

According to the method for preparing a lithium-ion battery, lithium-ion batteries including a lithium-rich positive electrode material are prepared by using the lithium-rich positive electrode materials prepared in Comparison Example 1 and Comparison Example 2, and battery numbers are set to 1.1 and 2.1. Lithium-ion batteries including a lithium-rich positive electrode material are prepared by using the lithium-rich positive electrode materials in Embodiment 1 and Embodiment 2 as the positive electrode material, and battery numbers are set to 1.2 and 2.2. Except that materials are different, all other conditions of the batteries numbered 1.1 and 2.1 are the same; likewise, except that materials are different, all other conditions of the batteries numbered 1.2 and 2.2 are the same.

Performance tests of the lithium-ion batteries:

An electrochemical performance test is performed on the lithium-ion batteries prepared in Embodiment 2 and the Comparison Examples.

Remarks in Table 1 and Table 2 show manners of a charge and discharge performance test and a cycle performance test.

The following Table 1 and Table 2 show results of the charge and discharge performance test, the cycle performance test, and a test of a capacity of initial discharge.

TABLE 1

| | | Efficiency (%) of | |
|---|---|---|---|
| Battery | Capacity (mAh/g) of | initial charge | Capacity (mAh/g) of |
| number | initial discharge | and discharge | 50 cycles |
| 1.1 | 237 | 79.4 | 215 |
| 1.2 | 260 | 83.6 | 243 |
| 2.1 | 248 | 77.6 | 228 |
| 2.2 | 281 | 85.4 | 263 |

Remarks: a charge and discharge current is 0.1 C, and a range of a charge and discharge voltage is 2 to 4.6 V.

TABLE 2

| | | Efficiency (%) of | |
|---|---|---|---|
| Battery | Capacity (mAh/g) of | initial charge | Capacity (mAh/g) of |
| number | initial discharge | and discharge | 50 cycles |
| 1.1 | 214 | 78.2 | 197 |
| 1.2 | 246 | 81.9 | 234 |
| 2.1 | 225 | 75.8 | 209 |
| 2.2 | 267 | 84.6 | 251 |

Remarks: a charge and discharge current is 1.0 C, and a range of a charge and discharge voltage is 2 to 4.6 V.

By comparing the experimental data of Table 1 with that of Table 2, the following conclusions can be drawn:

Compared with a lithium-rich positive electrode material whose surface is not coated with a modified Layered-Spinel structure, a lithium-rich positive electrode material whose surface is coated with a modified Layered-Spinel structure has the following advantages:

The lithium-rich positive electrode material whose surface is coated with a modified Layered-Spinel structure has a higher discharge capacity (as shown in Table 1 and Table 2), higher efficiency of initial charge and discharge (as shown in Table 1 and Table 2), better cycle performance (as shown in Table 1 and Table 2), and better rate performance (as shown in Table 2).

The foregoing descriptions are merely exemplary embodiments of the present invention, but are not intended to limit the present invention. Any modification, equivalent replacement, or improvement made without departing from the spirit and principle of the present invention should fall within the protection scope of the present invention.

What is claimed is:

1. A lithium-rich positive electrode material, comprising:
a coating structure comprising a core and a coating layer on the core;
wherein a general structural formula of the core of the coating structure is as follows:
z[xLi₂MO₃·(1−x)LiMeO₂]·(1−z)Li_{1+d}My_{2-d}O, wherein in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co; and
wherein the coating layer of the coating structure comprises a compound whose general formula is MₘM_{z}, wherein in the formula, Mₘ is at least one of Zn, Zr, and Al, and M_{z} is O or F.

2. The lithium battery positive electrode material according to claim 1, wherein a ratio of a radius of the core to a thickness of the coating layer is (25 to 100):1.

3. The lithium battery positive electrode material according to claim 1, wherein Li_{1+d}My_{2-d}O in the general structural formula of the core has a spinel structure.

4. The lithium battery positive electrode material according to claim 1, wherein xLi₂MO₃·(1−x) LiMeO₂ in the general structural formula of the core has a layered structure.

5. The lithium-rich positive electrode material according to claim 1, wherein a particle size of the lithium-rich positive electrode material is 5 μm to 10 μm.

6. A method for preparing a lithium-rich positive electrode material, the method comprising:
obtaining a precursor of the lithium-rich positive electrode material whose general structural formula is z[xLi₂MO₃·(1−x)LiMeO₂]·(1−z)Li_{1+d}My_{2-d}O, wherein in the formula, x and z are molar stoichiometric ratios, 0<x<1, 0<z<1, and 0<d<⅓; M is at least one of Mn, Ti, Zr, and Cr, Me is at least one of Mn, Co, Ni, Ti, Cr, V, Fe, Al, Mg, and Zr, and My is at least one of Mn, Ni, and Co; and
dispersing the precursor of the lithium-rich positive electrode material in a solution comprising an Mₘ salt, then adding an oxyhydroxide solution and stirring at 50 to 120° C. so that a reaction occurs, and then performing solid-liquid separation, washing, and drying, to obtain a first dried mixture, wherein Mₘ is at least one of Zn, Ti, Zr, and Al, and calcining the first dried mixture at 250 to 550° C. for 0.5 to 12 hours, to obtain the lithium-rich positive electrode material; or
dispersing the precursor of the lithium-rich positive electrode material in a solution comprising an Mₘ salt and a fluoride, and then stirring at 50 to 120° C. until the solution is dried, so as to obtain a second dried mixture, wherein Mₘ is at least one of Zn, Ti, Zr, and Al, and calcining the second dried mixture at 250 to 550° C. for 0.5 to 12 hours, to obtain the lithium-rich positive electrode material.

7. The method for preparing a lithium-rich positive electrode material according to claim 6, wherein the Mₘ salt is at least one of a nitrate, a sulphate, an acetate, and a chloride.

8. The method for preparing a lithium-rich positive electrode material according to claim 6, wherein the oxyhydroxide is at least one of NH₄OH, NaOH, and LiOH.

9. The method for preparing a lithium-rich positive electrode material according to claim 6, wherein when obtaining the first dried mixture and/or the second dried mixture, the precursor of the lithium-rich positive electrode material is dispersed in a mixed solution formed by the solution comprising the Mₘ salt, and a molar ratio of the precursor of the lithium-rich positive electrode material to the Mₘ salt is (25 to 100):1.

10. The method for preparing a lithium-rich positive electrode material according to claim 6, wherein when obtaining the first dried mixture, after the oxyhydroxide solution is added, pH of the solution comprising the Mₘ salt is adjusted to 9 to 12.

11. The method for preparing a lithium-rich positive electrode material according to claim 6, wherein when obtaining the first dried mixture, the Mₘ salt is a nitrate of Mₘ, and the oxyhydroxide is NH₄OH.

12. The method for preparing a lithium-rich positive electrode material according to claim 6, wherein when obtaining the second dried mixture, a pH of the solution comprising the Mₘ salt and the fluoride is 5 to 9.

13. The method for preparing a lithium-rich positive electrode material according to claim 6, wherein when obtaining the second dried mixture, the Mₘ salt is a nitrate of Mₘ, and the fluoride is NH₄F.

14. The method for preparing a lithium-rich positive electrode material according to claim 6, wherein obtaining the precursor of the lithium-rich positive electrode material comprises:
weighing a soluble M salt, a soluble Me salt, a soluble My salt and a lithium compound according to molar stoichiometric ratios of corresponding elements in the general structural formula z[xLi₂MO₃·(1−x)LiMeO₂]·(1−z)Li_{1+d}My_{2-d}O;
dissolving the M salt, the Me salt, and the My salt to prepare a mixed solution;
adding the mixed solution dropwise to the oxyhydroxide solution and stirring so that a reaction occurs, and successively performing solid-liquid separation, washing, and drying on a generated deposit to obtain a dried deposit; and
mixing the deposit with the lithium compound and performing sintering treatment, so as to obtain the precursor of the lithium-rich positive electrode material whose general structural formula is z[xLi₂MO₃·(1−x) LiMeO₂]·(1−z) Li_{1+d}My_{2-d}O.

15. The method for preparing a lithium-rich positive electrode material according to claim 14, wherein:
the M salt is at least one of an acetate, a nitrate, a sulphate, and a chloride of M;
the Me salt is at least one of an acetate, a nitrate, a sulphate, and a chloride of Me;
the My salt is at least one of an acetate, a nitrate, a sulphate, and a chloride of My; and
the lithium compound is at least one of lithium hydroxide and a lithium salt.

16. The method for preparing a lithium-rich positive electrode material according to claim 14, wherein a temperature of the sintering treatment is 500 to 1000° C., and a sintering time is 4 to 12 h.

17. A lithium battery positive electrode, comprising:
a current collector;
a positive electrode material combined on the current collector, wherein the positive electrode material comprises the lithium-rich positive electrode material according to claim 1.

18. A lithium battery, comprising:
the lithium battery positive electrode according to claim 17.
